(19) United States
(12) Patent Application Publication
(10) Pub. No.: US 2006/0209730 A1
(43) Pub. Date: Sep. 21, 2006

(54) Bi-directional audio bridge

(76) Inventor: Richard Bautista, La Mesa, CA (US)

Correspondence Address: THOMAS J. TIGHE & ASSOCIATES, 6265 GREENWICH DRIVE, SUITE 103, SAN DIEGO, CA, 92122, US

(21) Appl. No.: 11/084,469

(22) Filed: Mar. 19, 2005

(51) Int. Cl. H04L 12/28; H04L 12/56; H04B 3/20; H04B 3/30

(52) U.S. Cl. 370/285; 370/401

(57) ABSTRACT

Two half duplex communicators from separate networks each have an audio input port, an audio output port, and a terminal for receiving an external keying signal. Audio signal paths link respective audio output ports with respective audio input ports. Voice actuated circuits produce appropriate keying signals at the keying terminals of the communicators depending on the direction of the current audio signals. Preferably the keying circuits each include an audio amplifier having an adjustable gain, and a switching circuit responsive to a signal from the amplifier above a certain threshold for producing the keying signal, and preferably include a time delay circuit for delaying drop-out of the keying signals for a preset time after the amplifier signal has fallen below the threshold to prevent prematurely cutting-off audio before the speaker is finished talking.

### FIELD OF THE INVENTION

This invention relates in general to a bi-directional audio baseband bridge between two separate half-duplex communications networks, and in particular to such a bridge that couples to and between the separate networks via respective “auxiliary ports” as defined below.

### BACKGROUND OF THE INVENTION

As used herein, the term “auxiliary port” refers to and includes audio input and output ports commonly incorporated in such communicators for connecting external speakers and microphones. An “auxiliary port” as defined herein also includes a terminal for remote (from the communicator) keying of its communicator's PTT (push-to-talk) switch.

As will be seen from a further reading of this document, this invention provides an audio band bridge between any two separate half-duplex communications networks, whether or not they are mutually compatible, by linking two communicators, one from each network, via the communicators' respective auxiliary ports. This invention is used to great advantage when providing a baseband bridge between a long distance half-duplex audio communication network and a short range half-duplex audio communication network. An example of a long distance half-duplex communication network is a set (one or more) of cellular telephones from NEXTEL each of which incorporate a PTT feature called DIRECT CONNECT that operates at around 800 mHz. Examples of short range half-duplex networks are personal radio transceivers operating in the CB (Citizen Band), FRS (Family Radio Service), GMRS (General Mobile Radio Service), and MURS (Multi-Use Radio Service) frequency bands.

The following example illustrates a significant advantage of this invention. Example: the manager of a large resort may communicate with the resort's employees by means of personal short range communicators, as mentioned above, but heretofore when the manager traveled beyond the range of the resort's personal communication network, he or she was unable to exercise the same degree of supervision available via the resort's personal network. This invention solves that problem if the manager carries a cellular telephone with a PTT feature; it provides an audio band bridge between the manager's cellular PTT network and the resort's personal communication network. The bridge not only passes audio signals back and forth between the networks, but it also complies with the PTT constraints of the networks. Using this invention the manager can talk to all the resort's employees as if he or she was on site using one of the resort's personal short range communicators.

Other advantages and attributes of this invention will be readily seen by perusing the following text and drawings.

### SUMMARY OF THE INVENTION

The present invention favorably addresses the above described problems. The present invention provides an audio bridge between first and second, separate half duplex communication networks including: a first network communicator having an audio input port, an audio output port, and a terminal for receiving an external keying signal; a second network communicator having an audio input port, an audio output port, and a terminal for receiving an external keying signal; an audio signal path between the audio output port of the first network communicator and the audio input port of the second network communicator; an audio signal path between the audio output port of the second network communicator and the audio input port of the first network communicator; a first circuit responsive to an audio signal from the audio output port of the first network communicator for producing a keying signal at the terminal of the second network communicator; and a second circuit responsive to an audio signal from the audio output port of the second network communicator for producing a keying signal at the terminal of the first network communicator. Preferably both the first and second circuits each include an audio amplifier having an adjustable gain, and a switching circuit responsive to a signal level from the amplifier above a certain threshold for producing the keying signal. Preferably both the first and second circuits each further include a time delay circuit for delaying drop-out of the keying signal for a preset time, preferably about two seconds, after the amplifier signal level has fallen below the threshold. This is to prevent prematurely cutting-off audio before the speaker is finished talking. In the case of a communicator that responds with an audio indication, such as a bleep, when the communicator's PTT is actuated, the bridge preferably includes a disconnect circuit for disconnecting the audio path between the bleeping communicator's audio output port and the audio input port of the other communicator whenever the bleeping communicator is being keyed by audio coming in from the other communicator.

### BRIEF DESCRIPTION OF THE DRAWINGS

FIG. 1 is a block diagram of two distinct and incompatible communications systems audio coupled according to this invention.

FIG. 2 is a diagrammatic illustration of a bi-directional audio baseband bridge according to this invention.

### DESCRIPTION OF THE PREFERRED EMBODIMENT

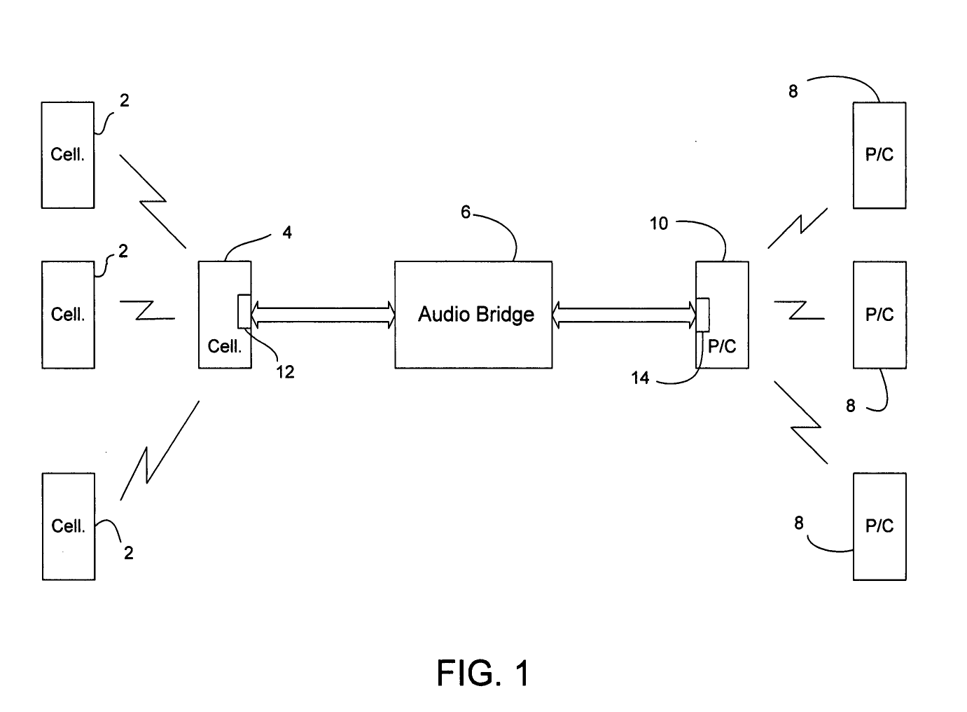

Referring to FIG. 1, a long distance, half duplex communication network is illustrated to be comprised of a set of cellular telephones 2, such as NEXTEL devices operating in their PTT or DIRECT CONNECTION mode. All these long distance communicators 2 are capable of communicating in half-duplex mode with a similar communicator 4 that is in bi-directional, audio band communication with an audio bridge 6 according to this invention. Also in audio band communication with the bridge 6 is a network comprised of a set of short range “personal” communicators 8 (labeled “P/C”) such as the previously mentioned personal radio transceivers operating in the CB (Citizen Band), FRS (Family Radio Service), GMRS (General Mobile Radio Service), and MURS (Multi-Use Radio Service) frequency bands. All these personal communicators 8 are capable of communicating in half-duplex mode with a similar personal communicator 10 that is in bi-directional, audio band communication with the audio bridge 6 according to this invention. As can be seen by FIG. 1, this invention can provide an audio band, bi-directional link between a long distance network of half duplex communicators and a short range network of half duplex, personal communicators. The link is established via auxiliary ports, 12 and 14 respectively, of the communicators, 4 and 10, in communication with the bridge.

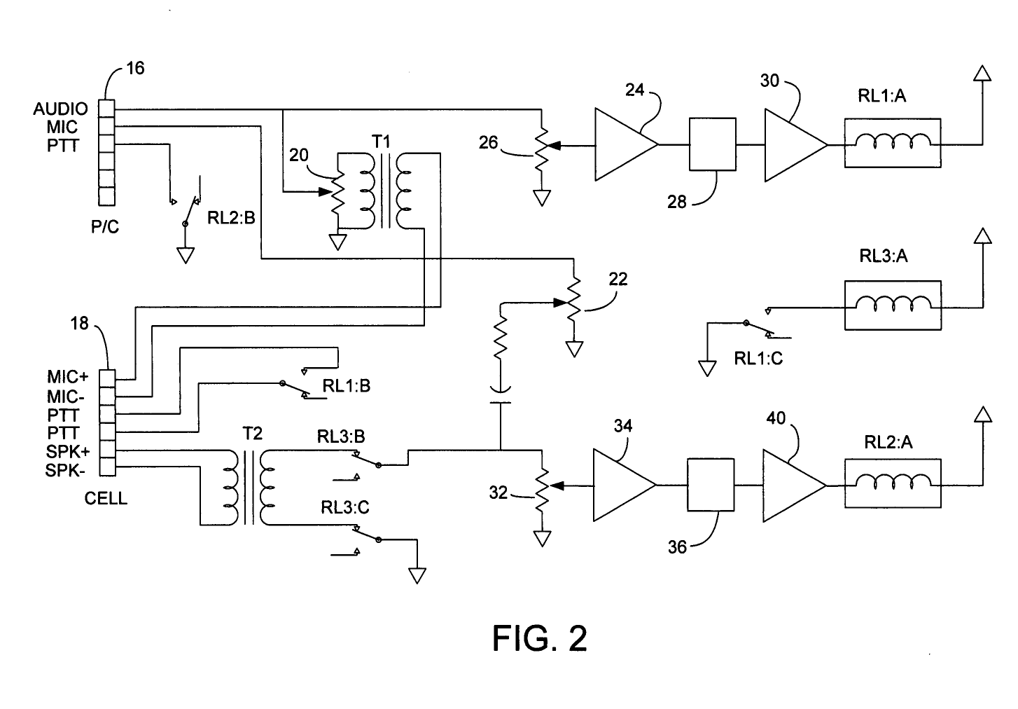

Referring to FIG. 2, an auxiliary port 16 of a communicator for a first network is illustrated to have an audio output port (AUDIO), an audio input port (MIC), and a terminal (PTT) for receiving an external keying signal. An auxiliary port 18 of a communicator for a second network is illustrated to also have an audio output port (SPK+ and SPK−), an audio input port (MIC+ and MIC−), and a terminal (PTT and PTT) for receiving an external keying signal. In the preferred embodiment, the audio output port from either or both communicators receives a signal from the communicator's audio discriminator which provides a relatively low level (e.g. 600 millivolts peak-to-peak) output.

An audio signal path between the audio output port of the first communicator and an audio input port of the second communicator is illustrated to include a transformer T1 for isolation. Across the primary winding of T1 is a potentiometer 20 the wiper of which is connected to the first communicator's audio output port (AUDIO). The secondary winding of T1 is connected to the audio input port (MIC+ and MIC−) of the second communicator. The potentiometer 20 is for adjusting as desired the signal level of the audio being sent from the first communicator to the second communicator's audio input port.

An audio signal path between an audio output port (SPK+ and SPK−) of the second communicator and an audio input port (MIC) of the first communicator is also illustrated to include an isolation transformer T2, the primary winding of which is connected across the second communicator's audio output port (SPK+ and SPK−). The two leads from the secondary of T2 are connected serially to respective, normally-closed contacts of a relay switch, RL3:B and RL3:C. When relay RL3 is energized, the contacts open and T2's secondary leads are then disconnected and the signal path is then open. As will be further explained below, relay RL3 is energized whenever relay RL1 is energized. When RL3 is not energized any signal developed across T2's secondary is fed to the wiper of a potentiometer 22 that is connected in serial between circuit ground and the first communicator's audio input (MIC). The potentiometer 22 is for adjusting as desired the signal level of the audio being sent from the second communicator to the first communicator's audio input port.

Referring again to FIG. 2, a first circuit responsive to an audio signal at the audio output port of the first communicator for producing a keying signal at a keying terminal of the second communicator is also illustrated. The audio output port (AUDIO) of the first communicator is also connected to the input of an amplifier 24 through a potentiometer 26 that is used to adjust the signal level at the input of the amplifier. In the preferred embodiment, the signal level at the amplifier input is 100-500 millivolts peak-to-peak and is therein amplified to about 2 volts peak-to-peak. The output of the amplifier is fed to a time delay circuit 28, preferably a resistor-capacitor circuit, that has a relatively short time constant when the signal level from the amplifier 24 is increasing in magnitude but a relatively long time constant when the amplifier signal level is decreasing. The output of the time delay circuit is fed to the input of a switching amplifier 30 and when the input signal level to amplifier 30 is at or above a preselected threshold the switching amplifier energizes RL1. Energization of RL1 causes the normally-open switch RL1:B to close, thus providing a keying signal to the second communicator's PPT terminal. The threshold level at the input of amplifier 30 is set to avoid spurious energization of RL1. The time delay circuit 28 delays any dropout (to below threshold) of the signal level at the input of the switching amplifier 30 by preferably substantially two seconds to avoid removal of the keying signal to the second communicator before the person speaking via the first communicator is finished talking.

Referring again to FIG. 2, a second circuit responsive to an audio signal at the audio output port of the second communicator for producing a keying signal at a keying terminal of the first communicator is also illustrated. The audio from the second communicator's output port (SPK+ and SPK−) is ultimately connected (through T2) to the input of an amplifier 34 through a potentiometer 32 that is used to adjust the signal level at the input of the amplifier. In the preferred embodiment, the signal level at the amplifier input is 100-500 millivolts peak-to-peak and is therein amplified to about 2 volts peak-to-peak. The output of the amplifier is fed to a time delay circuit 36, preferably a resistor-capacitor circuit, that has a relatively short time constant when the signal level from the amplifier 34 is increasing in magnitude but a relatively long time constant when the amplifier signal level is decreasing. The output of the time delay circuit is fed to the input of a switching amplifier 40 and when the input signal level to amplifier 40 is at or above a preselected threshold the switching amplifier energizes RL2. Energization of RL2 causes the normally-open switch RL2:B to close, thus providing a keying signal to the first communicator's PPT terminal. The threshold level at the input of amplifier 40 is set to avoid spurious energization of RL2. The time delay circuit 36 delays any drop-out (to below threshold) of the signal level at the input of the switching amplifier 40 by preferably substantially two seconds to avoid removal of the keying signal to the first communicator before the person speaking via the second communicator is finished talking.

Referring again to FIG. 2, the switches RL3:B and RL3:C in series with the leads of T2's secondary winding are for disconnecting the signal path between the second communicator's output port (SPK+ and SPK−) and the first communicator's input port (MIC) whenever RL1 is energized, that is, the second communicator's PTT terminal is being keyed. This is an optional circuit only needed in the case of a communicator that responds with an audio indication, such as a bleep, when the communicator's PTT is actuated. In the above described embodiment a similar disconnect circuit would be incorporated if the first communicator also responded to PTT keying with an audible indicator.

While the embodiment described above shows this invention bridging a long distance network and a short range network, it should be understood that it can be used to bridge short range to short range, and long distance to long distance, or any combination thereof. This invention is a bi-directional audio band bridge that allows interconnection between any two-way radios and other devices (such as cellular PTT 800 mHz digital networks, VHF, UHF, 900 mHz band radios). This audio bridge is used to best advantage by allowing voice transmission between different protocols and systems, thus solving multi-band interoperability. For example, a UHF analog radio that works in 400 mHz will receive a signal on it's channel that is reproduced by the audio speaker which will be re-transmitted by a digital radio in 800 mHz with a different protocol and vice versa.

The foregoing description and drawings were given for illustrative purposes only, it being understood that the invention is not limited to the embodiments disclosed, but is intended to embrace any and all alternatives, equivalents, modifications and rearrangements of elements filling within the scope of the invention as defined by the following claims.

I claim:

1. An audio bridge between first and second separate half duplex communication networks comprising:
(a) a first network communicator having an audio input port, an audio output port, and a terminal for receiving an external keying signal;
(b) a second network communicator having an audio input port, an audio output port, and a terminal for receiving an external keying signal;
(c) an audio signal path between the audio output port of the first network communicator and the audio input port of the second network communicator;
(d) an audio signal path between the audio output port of the second network communicator and the audio input port of the first network communicator;
(e) a first circuit responsive to an audio signal at the audio output port of the first network communicator for producing a keying signal at the terminal of the second network communicator; and
(f) a second circuit responsive to an audio signal at the audio output port of the second network communicator for producing a keying signal at the terminal of the first network communicator.

2. The bridge according to claim 1 wherein the first circuit comprises an audio amplifier having an adjustable gain, and a switching circuit responsive to a signal from the amplifier above a certain threshold for producing the keying signal.

3. The bridge according to claim 2 wherein the second circuit comprises an audio amplifier having an adjustable gain, and a switching circuit responsive to a signal from the amplifier above a certain threshold for producing the keying signal.

4. The bridge according to claim 2 wherein the first circuit further comprises a time delay circuit for delaying drop-out of the keying signal for a preset time after the amplifier signal has fallen below the threshold.

5. The bridge according to claim 3 wherein the second circuit further comprises a time delay circuit for delaying drop-out of the keying signal for a preset time after the amplifier signal has fallen below the threshold.

6. The bridge according to claim 1 further comprising a disconnect circuit for disconnecting the audio path between the audio output port of the second network communicator and the audio input port of the first network communicator whenever the first circuit is producing the keying signal.

7. The bridge according to claim 2 further comprising a disconnect circuit for disconnecting the audio path between the audio output port of the second network communicator and the audio input port of the first network communicator whenever the switching circuit is producing the keying signal.

8. An audio bridge between first and second half duplex communicators each having an auxiliary port, the bridge comprising:
(a) an audio signal path between an audio output port of the first communicator and an audio input port of the second communicator;
(b) an audio signal path between an audio output port of the second communicator and an audio input port of the first communicator;
(c) a first circuit responsive to an audio signal at the audio output port of the first communicator for producing a keying signal at a keying terminal of the second communicator; and
(d) a second circuit responsive to an audio signal at the audio output port of the second communicator for producing a keying signal at a keying terminal of the first communicator.

9. The bridge according to claim 8 wherein the first circuit comprises an audio amplifier having an adjustable gain, and a switching circuit responsive to a signal from the amplifier above a certain threshold for producing the keying signal.

10. The bridge according to claim 9 wherein the second circuit comprises an audio amplifier having an adjustable gain, and a switching circuit responsive to a signal from the amplifier above a certain threshold for producing the keying signal.

11. The bridge according to claim 9 wherein the first circuit further comprises a time delay circuit for delaying drop-out of the keying signal for a preset time after the amplifier signal has fallen below the threshold.

12. The bridge according to claim 10 wherein the second circuit further comprises a time delay circuit for delaying drop-out of the keying signal for a preset time after the amplifier signal has fallen below the threshold.

13. The bridge according to claim 8 further comprising a disconnect circuit for disconnecting the audio path between the audio output port of the second communicator and the audio input port of the first communicator whenever the first circuit is producing the keying signal.

14. The bridge according to claim 9 further comprising a disconnect circuit for disconnecting the audio path between the audio output port of the second communicator and the audio input port of the first communicator whenever the switching circuit is producing the keying signal.
